(19) United States
(12) Patent Application Publication
(10) Pub. No.: US 2003/0227553 A1
(43) Pub. Date: Dec. 11, 2003

(54) Systems and methods for image indexing

(76) Inventors: Steve Mattis, Boise, ID (US); Clint S. Cuzzo, Star, ID (US)

Correspondence Address: HEWLETT-PACKARD COMPANY, Intellectual Property Administration, P.O. Box 272400, Fort Collins, CO, 80527-2400, US

(21) Appl. No.: 10/171,315

(22) Filed: Jun. 11, 2002

(51) Int. Cl. H04N 5/76

(52) U.S. Cl. 348/231.2

(57) ABSTRACT

The described arrangements and procedures provide a user interface, which may or may not be displayed by an imaging device, for a user to specify a data storage location to index or store a digital image that is acquired by the imagining device.

### TECHNICAL FIELD

The described subject matter relates to imaging devices. In particular the subject matter pertains to automatically indexing acquired images.

### BACKGROUND

Photographs, clip art, and so on are often digitized through the use of digital photography or by scanning in such images. After acquiring a digital image, an image archival utility may be used to analyze the image in an attempt to store the image onto an appropriate data storage device or into a corresponding directory folder. Unfortunately, such image analysis (e.g., optical character recognition (OCR)) is not error free and cannot always correctly determine the subject matter or context of an acquired digital image. Based on such incorrect image analysis, the image archival utility may store the document into an inappropriate data storage location. The following described subject matter addresses these and other problems of archiving or storing digital images into a corresponding directory location.

### SUMMARY

The described arrangements and procedures provide a user interface, which may or may not be displayed by an imaging device, for a user to specify a data storage location to index or store a digital image that is acquired by the imaging device.

### BRIEF DESCRIPTION OF THE DRAWINGS

The same numbers are used throughout the drawings to reference like features and components.

FIG. 1 shows an exemplary imaging device to index acquired images.

FIG. 2 shows aspects of an exemplary imaging device user interface system to index images into a data storage location. Specifically, FIG. 2 shows a directory resource window for selecting locations within which to index images.

FIG. 3 shows further aspects of an exemplary imaging device user interface system to index images. Specifically, FIG. 3 shows a dropdown menu for selecting predefined directory locations to index acquired images.

FIG. 4 shows an exemplary system to index images into networked data storage locations.

FIG. 5 shows an exemplary procedure to index images acquired from an imaging device.

### DETAILED DESCRIPTION

Overview

The described arrangements and procedures provide an imaging device interface to index acquired images into a directory that is either local to the imaging device or physically distributed across multiple devices and logically centralized at the imaging device.

Exemplary Imaging Device

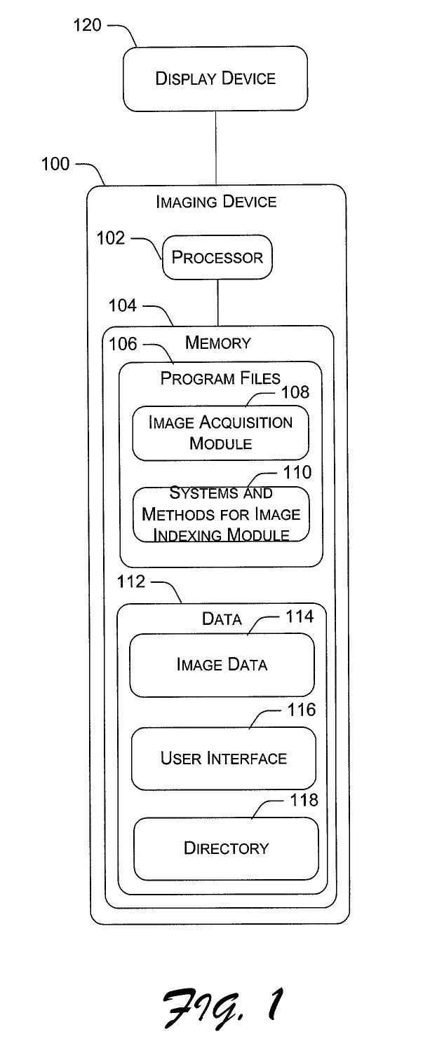

FIG. 1 shows an exemplary imaging device 100 to index acquired images into a directory 118. The imaging device 100 digitizes an image by dividing it into a grid of boxes and representing each box with either a zero or a one, depending on whether the box is filled in. For color and gray scale images, the same principle applies, but each box is then represented by multiple bits (e.g., 24 bits) of data. The resulting matrix of bits is called a bitmap. Optical scanners and digital cameras are examples of imaging devices 100 that digitize acquired images.

The imaging device 100 includes a processor 102 that is coupled to a system memory 104. The system memory includes any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk drive, a floppy diskette, a flash memory card, a CD-ROM, etc.

The processor 102 is configured to fetch and execute computer program instructions from application programs 106 such as the image acquisition module 108, the image indexing module 110, a directory service (e.g., a service based on Lightweight Directory Access Protocol (LDAP)—the directory service is not shown), an operating system (not shown), and so on. The processor also stores and fetches data 112 such as image data 114, the user interface 11 6, and directory data 118 while executing the application programs.

The image acquisition module 108 acquires or digitizes images 114 from any of a number of image sources. For instance, if the device 100 is a digital camera, the images 114 are anything that can be captured or recorded by the camera. In another example, if the device 100 is a scanner, images 114 include scanned paper documents, photographs, transparencies, and in general, anything that can be positioned on a scanner platen for acquisition or digitization.

The image indexing module 110 displays a user interface 116 (UI) to a display device 120 (e.g., a computer monitor, a liquid crystal display, and so on) that is operatively coupled to the imaging device 100. Such UI elements include any combination of text and/or graphic based elements that can be selected or otherwise interacted with by the user to indicate a destination for acquired image data.

For instance, the UI elements may include text controls, button controls, dialog boxes, menus and corresponding menu items, scroll bars, etc. Pointing devices (e.g., a mouse control), touch sensitive displays, voice commands, keyboards, input keys, and so on, are several of many possible ways for the user to interact (e.g., select) with the user interface controls, input text, and so on.

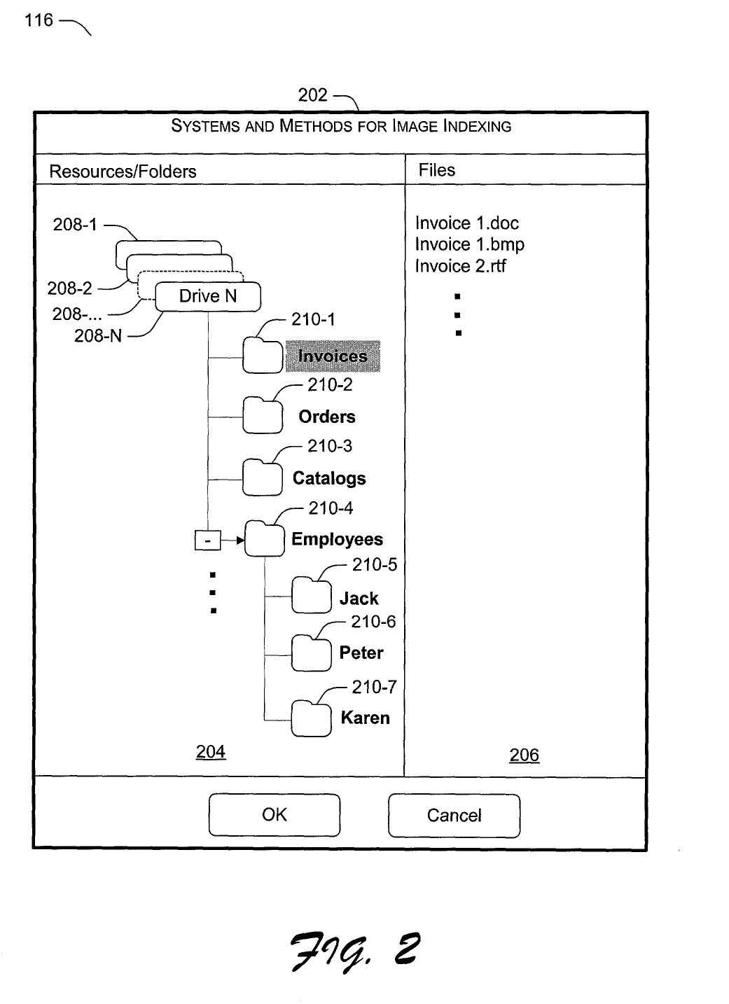

FIG. 2 shows an exemplary imaging device user interface 116 (UI) to index acquired documents into a particular data storage location (e.g., a directory resource, a database, a server, a folder, a data storage device, and so on). This example illustrates a UI for specifying a directory resource. Directories are typically logically distributed across multiple computing device and data storage devices. Thus, just about any data storage device or memory location can be accessed from a directory.

This exemplary UI includes a window 202 divided into a resource/folder portion 204 and a file list portion 206. These portions display directory 118 resources. Specifically, a storage or logical storage portion 204 of the window includes controls to represent one or more storage drives 208 and folders 210 positioned hierarchically thereunder. A file list 206 portion of the window 202 displays any files (e.g., documents, bitmaps, etc.) in a default or user selected drive 208 or folder 210.

Responsive to user selection of a data storage location such as a physical or logical drive 208, any folders 210 available for user access are displayed with respect to the selected resource 208. Additionally, any files (e.g., documents, bitmaps, multimedia files, and so on) corresponding to the selected resource 208 or 210 are identified in the file list portion 206. A “save-as” and/or confirmation dialog box (not shown) may also be displayed as part of the UI 116 to provide an opportunity to specify one or more particular file names to identify one or more acquired images and/or to confirm potential file overwrites.

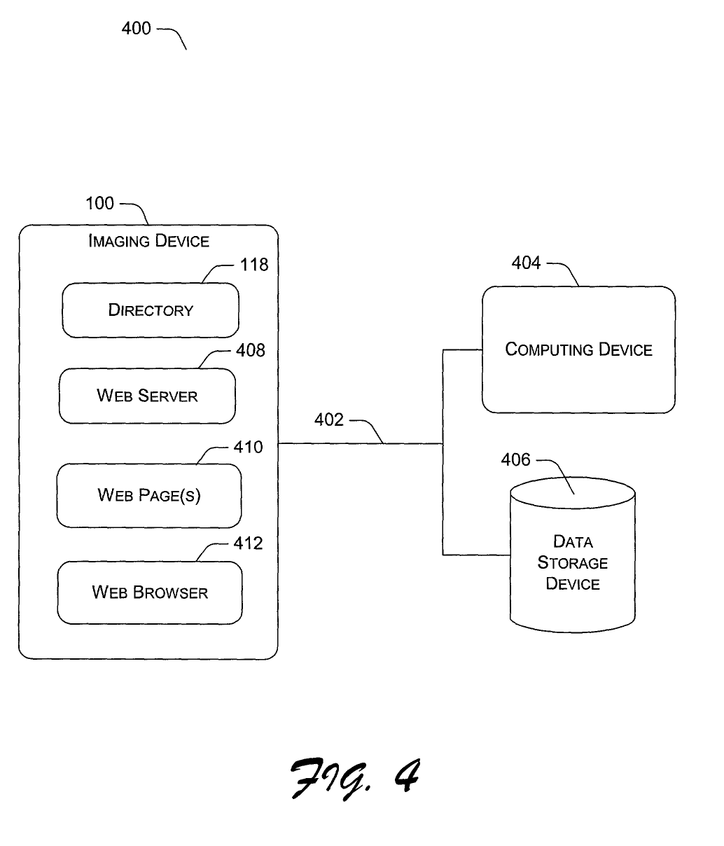

Although the exemplary UI of window 202 displays directory 118 resources, it can be appreciated that other data storage locations or devices can be illustrated in the window 202. For instance, the window 202 may be used to display a Web browser UI (e.g., a UI of Web browser 410 of FIG. 4) to specify that the imaging device 100 is to index images at networked locations such as a Web server (e.g., identified via a Universal Resource Locator (URL)). An exemplary networked imaging device 100 is described in greater detail below in reference to FIG. 4.

Accordingly, UI 116 provides for user selection of a particular location (e.g., a specific data storage device 208, a folder 210, a file to overwrite, a networked device, a Web server, a database, etc.) within which to index acquired images 114.

The imaging device 100 may still employ techniques such as OCR to analyze an acquired image, providing an initial estimation of where an acquired image is to be stored. Such an initial estimation can be based on any number of various algorithms that are implementation specific. For instance such an algorithm may correspond to document subject matter, context, author, and so on. However, the user can use the UI 116 to override or verify any such original estimation by specifically indicating where the acquired image 114 is to be organized or stored.

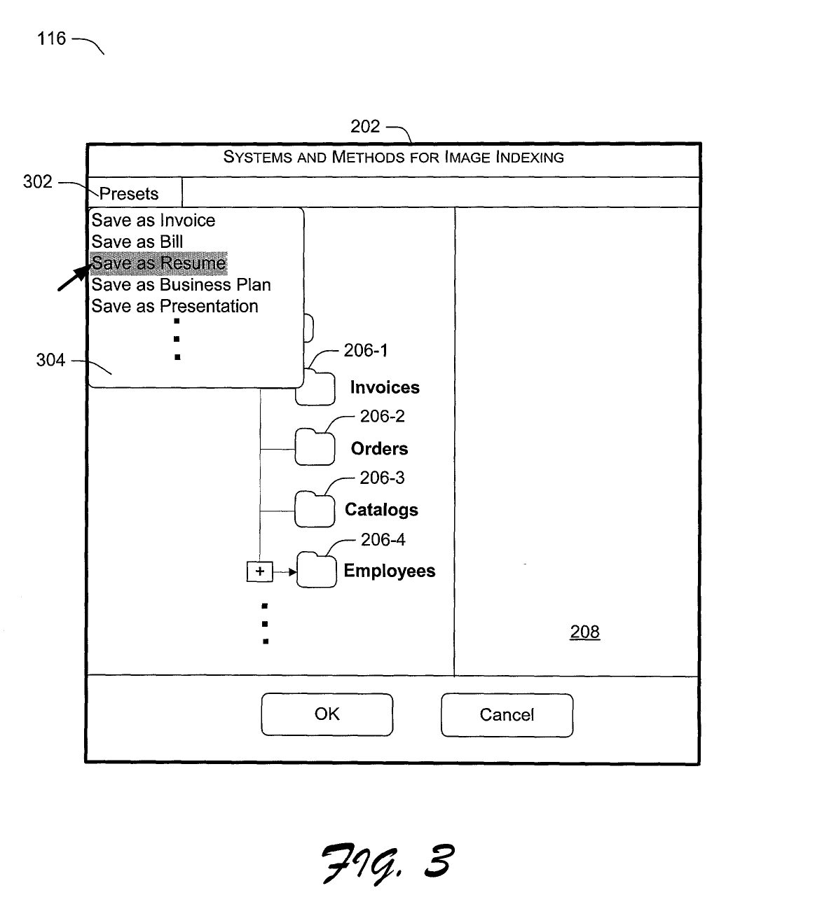

FIG. 3 shows further aspects of an exemplary imaging device UI 116 to index images into a directory 118. Specifically, the UI 116 includes a preset menu item 302. Upon user selection of menu item 302, a dropdown menu 304 provides for user selection of one or more predefined locations to index images 114. The predefined locations are identified in the menu 304 in any manner that suits the needs or desires of the user or organization. For instance, the predefined locations can be mapped to networked location such as a Web server (e.g., identified via a URL), directory 118 locations based on the subject matter (e.g., invoices, bills, resumes, business plans, presentations, etc.) or other context of the image data.

To illustrate this, consider that if the user or organization frequently acquires images of resumes, a “resume” menu item may be added to the drop-down menu 304. The resume menu item can be mapped to a particular storage location (drive and folder, Web server, database, and so on) where resumes are to be stored. Before or after acquiring one or more resume images, the user can select this menu item to automatically index the images into the particular storage location. (This is shown by the cursor at the highlighted “resume” menu item).

Although FIGS. 2 and 3 show portions of the UI 116 as a windowing UI, any type of UI can be used to indicate where acquired image data 114 is to be indexed. For example, a user can use a text-based UI, a touch-sensitive display screen, hardwired input keys, and so on, to indicate where acquired image data 114 is to be stored.

FIG. 4 shows aspects of an exemplary system 400 to index acquired images to data storage locations that are accessed in a networked environment (e.g., an environment wherein the directory 118 is logically centralized but physically distributed across multiple computing devices 404, an intranet, the Internet, etc.). Specifically, the imaging device 100 is coupled across communications medium 402 to one or more other computing devices 404 and/or one or more data storage device 406. The communication medium 402 is a parallel connection, a packet switched network (e.g., an organizational intranet network), the Internet, and/or other communication configurations that provide electronic exchange of information between the image device 100 and one or more computing devices 404 and/or data storage devices 406 using an appropriate protocol (e.g., TCP/IP, UDP, SOAP, etc.).

The computing device 404 is implemented as a personal computer (PC), server, Web Server, or other device configured to communicate with the image acquiring or forming device 100. Other system 400 arrangements are possible including additional imaging devices 100, and/or additional computing devices 404.

In the system 400, the imaging device 100 further includes an embedded Web server 408 for communicating Web pages 410 to a computing device 404, and a Web browser 412 for indexing image data 114 onto a networked data storage device 406. The computing device 404 includes, for example, an application such as a browser (not shown) for displaying the communicated Web pages 410 to a user. Such Web pages 410 may include a user interface (not shown) to remotely control the imaging device's imaging acquisition characteristics. Such imaging device 100 acquisition control UIs include, for instance, a TWAIN UI, which is distributed with the imaging device 100.

Additionally, such Web pages 410 may be utilized to display the exemplary UIs 116 of FIGS. 3 and 4 on the remote computer 404, thereby allowing a user at a remote device to indicate a directory location to index acquired images (e.g., documents, bitmaps, etc.). Furthermore, the Web pages 410 may include an imaging device administrative UI allowing an administrator to remotely manage user access to specific ones of the distributed directory 118 resources. In this manner, certain users may be provided with capability to index acquired images to specific ones of the directory 118 resources, whereas other users may be denied such access through Web pages 410 implementation of administrative policy.

Computer-Readable Media

The subject matter of FIGS. 1 and 4 are illustrated as being implemented in a suitable computing environment. Although not required, the subject matter is described in the general context of computer-executable instructions, such as the program modules 106 of FIG. 1 that are respectively executed by the imaging device 100. Program modules typically include routines, programs, objects, components, data structures, etc., that perform particular tasks or implement particular abstract data types. Additionally, those skilled in the art will appreciate that the described arrangements and procedures may be practiced with other computer system configurations, including multi-processor systems, microprocessor-based or programmable consumer electronics, network PCs, minicomputers, mainframe computers, and so on. In a distributed computing environment, program modules may be located in both local and remote memory storage devices (computer-readable media).

Exemplary Procedure

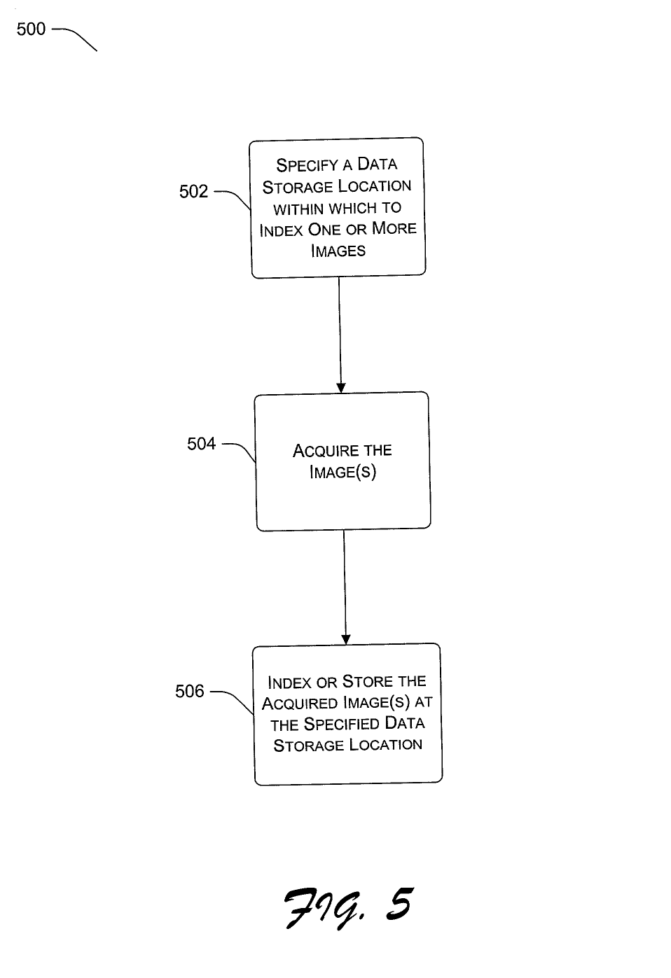

FIG. 5 shows aspects of an exemplary procedure 500 to index acquired images into a local or distributed data storage location. At block 502, a user specifies a data storage resource within which to index or store one or more acquired images (e.g., an imaging job). For instance, a user can specify a particular directory location, Web server, database, file or folder, and so on, to index acquired images using the exemplary UIs 116 of FIGS. 3 and 4. The user can accomplish this at the imaging device 100 or at a remote computer 404 such as a general purpose computer, a personal digital assistant (PDA), a mobile phone, and so on (e.g., via communication of the Web pages 408 to the remote computer 404).

At block 504, the procedure 500 acquires the images at the imaging device. There are any of a number of procedures that can be used to acquire images from the imaging device. For instance, if the device 100 is a scanner, one or more images are scanned in from the scanner platen—possibly using an automatic document feeder to position multiple images onto the platen as a scan job. In another example, if the imaging device 100 is a digital camera, the image may be a scene or media file (e.g., an audio and/or video multimedia file) that is being digitized.

Block 504 can be performed before block 502, wherein the images may have already been acquired before a user specifies the location within which to store the acquired images. Regardless of whether block 502 is performed before block 504, or vice versa, the user specifies where to index the imaging device's 100 to be acquired or already acquired images.

At block 506, the acquired images are stored at the user specified data storage location (block 502).

Conclusion

Although the subject matter has been described in language specific to structural features and/or methodological operations, it is understood that the arrangements and procedures defined in the appended claims is not necessarily limited to the specific features or operations described. Rather, the specific features and operations are disclosed as preferred forms of implementing the claimed subject matter.

1. A method for indexing digitized images, the method comprising:
providing, by an imaging device, a user interface to specify a data storage location to index an image;
specifying the data storage location based on the user interface;
acquiring the image; and
indexing the image at the data storage location.

2. A method as recited in claim 1, wherein the imaging device is a scanning device.

3. A method as recited in claim 1, wherein the imaging device is a digital camera.

4. A method as recited in claim 1, wherein the data storage location is local to the imaging device.

5. A method as recited in claim 1, wherein the data storage location is remote to the imaging device.

6. A method as recited in claim 1, wherein providing the user interface further comprises, displaying, by the imaging device, the user interface.

7. A method as recited in claim 1, wherein providing the user interface further comprises communicating, by the imaging device, a Web page representing the user interface to a remote computer for display.

8. A method as recited in claim 1, further comprising an act of administering, at the imaging device, user access to the data storage location.

9. A method as recited in claim 1, further comprising an act of administering, at a remote computer, user access to the data storage location.

10. A computer-readable medium comprising computer-executable instructions for an imaging device to perform acts comprising:
providing a user interface to specify a data storage location to index an image, the data storage location indicating a context corresponding to the image;
specifying the context based on the user interface;
acquiring the image; and
archiving the image based on the context.

11. A computer-readable medium as recited in claim 10, wherein the context is identified by a particular data storage location from a plurality of predetermined data storage locations.

12. A computer-readable medium as recited in claim 10, wherein the imaging device is a digital camera.

13. A computer-readable medium as recited in claim 10, wherein the data storage location is local to the imaging device.

14. A computer-readable medium as recited in claim 10, wherein the data storage location is logically centralized by the user interface.

15. A computer-readable medium as recited in claim 10, wherein the computer-executable instructions for providing the user interface further comprises computer-executable instructions for displaying, by the imaging device, the user interface.

16. A computer-readable medium as recited in claim 10, wherein the computer-executable instructions for providing the user interface further comprises computer-executable instructions for communicating, by the imaging device, a Web page representing the user interface to a remote computer for display to a user.

17. A computer-readable medium as recited in claim 10, further comprising computer-executable instructions for administering, at the imaging device or from a remote location, user access to the data storage location.

18. An imaging device for acquiring and indexing images, the imaging device comprising:
a memory comprising computer-executable instructions; and
a processor coupled to the memory to fetch and execute the computer-executable instructions from memory to perform acts comprising:
providing a user interface to specify a data storage location to index an image;
specifying the data storage location based on the user interface;
acquiring the image; and
indexing the image at the data storage location.

19. An imaging device as recited in claim 18, wherein the imaging device is a scanning device or a digital camera.

20. An imaging device as recited in claim 18, wherein the data storage location is local or remote to the imaging device.

21. An imaging device as recited in claim 18, wherein the computer-executable instructions for providing the user interface further comprises computer-executable instructions for displaying, by the imaging device or by a computing device that is remote from the computing device, the user interface.

22. An imaging device as recited in claim 18, wherein the user interface is a Web page.

23. An imaging device as recited in claim 18, further comprising computer-executable instructions for administering, at the imaging device or at a location remote to the imaging device, user access to the data storage location.

24. In imaging device for acquiring and indexing images, the imaging device comprising:
means for:
(a) providing a user interface to specify a data storage location to index an image;
(b) specifying the data storage location based on the user interface;
(c) acquiring the image; and
(d) indexing the image at the data storage location.

25. An imaging device as recited in claim 24, wherein the data storage location is local or remote to the imaging device.

26. An imaging device as recited in claim 24, wherein the means for providing the user interface further comprises means for displaying, by the imaging device or by a different device that is remote from the imaging device, the user interface for subsequent user interaction.
